(19) United States
(12) Patent Application Publication
(10) Pub. No.: US 2003/0182580 A1
(43) Pub. Date: Sep. 25, 2003

(54) Network traffic flow control system

(76) Inventor: Jai-hyoung Lee, Seoul (KR)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 10/362,498

(22) PCT Filed: Apr. 4, 2002
(86) PCT No.: PCT/KR02/00599

(30) Foreign Application Priority Data
May 4, 2001 (KR) 2001/24311

(51) Int. Cl. H04L 9/00

(52) U.S. Cl. 713/201

(57) ABSTRACT

The present invention relates to a network traffic flow control system, more specifically to a system which separates networks physically and controls the flow of packets moving on the computer networks at the data link level without changing the constitution and environment of current network.

### TECHNICAL FIELD

The present invention relates to a network traffic flow control system, in particular, to a network traffic control system capable of controlling the flow of packets moving in a computer network at data link layer without changing the constitution and environment of the existing network, while physically separating the network.

### BACKGROUND ART

With increasing use of the Internet, the negative effect thereof is also growing gradually, a typical example of such ill effect is the so-called ‘hacking’, which represents manipulation of data and/or outflow of information stored in a computer by an unauthorized user after the user has intruded in an internal network via the Internet. In order to prevent information stored in a computer from hacking, it may be eventually necessary to cut off accesses to a specific URL and/or accesses from a certain IP address.

A hardware or software means for achieving such objectives is generally called a ‘security solution’, which can roughly be classified in accordance with its function into an ‘intrusion cut off system’ also called a “firewall” or an ‘intrusion detecting system’. An intrusion cut off system is a system for cutting off any unauthorized users' intrusion from an external network into an internal network from its origin, while an intrusion detecting system is a system for monitoring whether an unauthorized intrusion has occurred in the network and warning thereof, if any such intrusion has occurred

However, in a high-speed network such as a Giga-bit network, a security system frequently can no more effectively achieve its objectives with just one intrusion cut off system or one intrusion detecting system. For solving this problem, various methods listed in the following have been presented, each of which has its own problem as stated below.

The first method is to substitute a security system with a larger system. However, there can be a huge network that cannot be processed even by a large security system, and even if there is one such system, the costs for the hardware and the system would be too high.

The second method is to scatter the loads to a plurality of systems. Problems with this method, however, are that it requires a more delicate constitution of the intrusion cut off system, and that a change in the network requires a corresponding change in the environment of all systems related with enterprises or organizations. Those problems can easily overload the administrator, resulting in rapid increase in time and costs for maintaining the internal system.

Third, an intrusion detecting system based on a network generally reads a packet by connecting to a general hub not having switching function. However, a general hub without switching function is normally not used, because it causes packet collisions in a high-speed network with much traffic. Accordingly, loading the network shall be avoided in a high-speed network using the mirroring port of a switching hub. However, since the mirroring port of a switching hub is a means for confirming whether a network-device properly functions or not, and is not a means provided for the purpose of a security system, only one mirroring port is normally provided for. Thus, scattering of the loads to various systems will be more difficult when the intrusion detecting system is overloaded.

The fourth method is to constitute, in relation with said third method, multiple systems by connecting an intrusion detecting system to each hub after multiple switching hubs have been serially connected. However, here arise the same problems as those of the intrusion cut off system, i.e. the system and network administration will be difficult, and time and costs for the maintenance will rapidly increase.

The fifth method is to adopt a Network Address Translator (hereinafter, “NAT”) for an intrusion cut off system related with said second method, whereby the NAT is applied to all packets using the Internet. In such case, after the intrusion cut off system to which the NAT is applied in sequence must be passed through, a switching must be performed for scattering the loads to multiple intrusion cut off systems, which procedure cannot be said to be an effective scattering of the loads.

Sixth, although an intrusion detecting system is provided with a capacity to cut off TCP session to a certain degree, it fails to cut off entirely. Accordingly, if a result of an intrusion detecting brings about a rule for cut off, the cut off rule shall be designated in connection with the intrusion cut off system. In this case, a system is required, which can immediately reflect the detecting result to the intrusion cut off in connection with the intrusion cut off system.

The difference between an intrusion detecting system and an intrusion cut off system can be described as follows: Since an intrusion cut off system is made in form of a router or a system gateway, all packets moving in the network are processed by executing gateway program of a system. Thus, a bottleneck phenomenon occurs always in the intrusion cut off system. Furthermore, if the gateway is placed in the center of the network, this necessarily causes changes in the constitution of the network. Accordingly, the inside IP address system as well as the outside IP address system of the gateway shall be checked.

On the other hand, an intrusion detecting system based on a network sniffs the packets floating in the network not to cause a bottleneck. In addition, an intrusion detecting system is advantageous in that it allows easy administration of the network, because it cannot change topology of the network by itself. However, by wiretapping of the floating packets, neither cut off of a packet nor performing of other necessary manipulation can be done. In certain TCP sessions, cut off of sessions using the characteristics of the TCP protocol may be possible but, a cut off of communication is originally not possible in various other protocols including the UDP protocol.

To solve the above problems, development of a system capable of effectively scattering the loads on a gateway type system such as an intrusion cut off system, a system capable of effectively scattering the loads on an intrusion detecting system, and a system wherein said two systems are mixed or wherein any one of said two systems is supported, while not requiring any change in the constitution or environment of the network like a bridge, is desirable.

### DISCLOSURE OF THE INVENTION

To solve the above problems, an object of the present invention is to provide a load scattering type network traffic flow control system comprising an intrusion detecting system and an intrusion cut off system. Namely, a network traffic flow control system is provided, which can separate physically a network and have logically one network address while requiring no change in the constitution or environment of the existing network.

Another objective of the present invention is to provide a network traffic flow control system, which can reduce loads on an intrusion cut off system by processing a part of packets for itself and by filtering the other packets to transmit to the above intrusion cut off system.

Another objective of the present invention is to provide a network traffic flow control system, which allows application of a general gateway application program including an intrusion cut off system while not causing a bottle neck at locations where a network branches.

Another objective of the present invention is to provide a network traffic flow control system capable of scattering loads by linking a plurality of intrusion cut off systems and of intrusion detecting systems.

Still another objective of the present invention is to provide a network traffic flow control system capable of combining a plurality of intrusion detecting systems with network monitoring systems while maintaining the load on the network almost to the layer of 0, by connecting switching device to the mirroring port.

Another objective of the present invention is to provide a network traffic flow control system, which can immediately reflect a rule detected by the intrusion detecting system to the intrusion cut off system.

Still another objective of the present invention is to provide a network traffic flow control system, which can support a high speed network in wire-speed, by solving problems arising from high speed processing of the packets moving via a high speed network under a general operation system, by enabling the packets to be mounted in the kernel of the general operation system.

In order to achieve the above objectives, the present invention provides a network traffic flow control system which is installed between two or more networks based on broadcasting is connected to one or more intrusion cut off systems and one or more intrusion detecting systems. The intrusion cut off system determines whether or not to cut off transmission/receiving of the packets between the above networks in accordance with predetermined rules. And the intrusion detecting system monitors flow of the packets between the networks in accordance with predetermined rules.

The network traffic flow control system comprises an internal interface, an external interface, a rule inquiring and filtering module, and a mirroring interface.

The internal interface transmits/receives the packets while connected to the internal network. The external interface transmits/receives the packets while connected to the external network. The rule inquiring and filtering module is connected to the internal interface, the external interface, and the intrusion cut off system, and determines whether or not to cut off the packets received from the internal interface or the external interface in accordance with predetermined rules.

The mirroring interface mirrors selectively the packets received from the internal interface or the external interface in accordance with predetermined rules to the intrusion detecting system, while it is connected to the internal interface, the external interface, and the intrusion detecting system. The predetermined rules in the rule inquiring and filtering module, and in the mirroring interface controls a flow of the packets on the data link layer.

Further, the present invention provides a network traffic flow control system comprising additionally a NAT, which converts the above internal network address system to the above external network address system and vice versa, while it is inserted between the above rule inquiring and filtering module and the above external interface.

In addition, each of the internal interface and the external interface comprises a receiving buffer part, a transmission buffer part, and a flow control rule database. The receiving buffer part stores temporarily the packets received from the internal network or the external network. The transmission buffer part stores temporarily the packets to be transmitted to the internal network or the external network. The flow control rule database stores rules for determining whether or not to mirror the packets stored in the receiving buffer part to the mirroring interface.

Furthermore, the mirroring interface comprises a shared memory part, a transmission packet administration part, a network interface, and receiving packet administration part. The shared memory part stores temporarily the packets mirrored from the above internal interface or the external interface. The transmission packet administration part transmits to the network interface after fetching the packets from the shared memory part. The network interface transmits to the intrusion detecting system after receiving the packets from the transmission packet administration part. The receiving packet administration part transmits the received packets to the rule inquiring and filtering module in a case that the packet is received from the intrusion detecting system through the network interface.

In addition, a network traffic flow control system of the present invention further comprises a communication/administration interface including a first communication module, a second communication module, a rule database, a log database, and a statistics database. The first communication module enables the clients to access to networks. The second communication module enables access to the intrusion cut off system. The rule database stores predetermined intrusion cut off rules and intrusion detecting rules, and transmits the rules to the rule inquiring and filtering module. The log database stores records on all packets passing the network. The statistics database stores statistical information of the packets in the network.

Moreover, the above packet cut off rules are distributed to the above rule database, to the rule inquiring and filtering module, and to the above intrusion cut off system in accordance with predetermined criteria.

Further, the above cut off rules generated by the results of detecting by the above intrusion detecting system are transmitted immediately to the above rule database, to the above rule inquiring and filtering module, and to the above intrusion cut off system, so that the corresponding data is updated.

Furthermore, another embodiment of the present invention provides a network traffic flow control system, which is installed between two or more networks based on broadcasting through the switching device. The network traffic flow control system is connected to one or more intrusion detecting systems that monitors flow of the packets in accordance with predetermined rules and performs multiple mirroring to said one or more intrusion detecting systems through a plurality of network interfaces.

The network traffic flow control system according to the present invention further comprises a mirroring interface, which mirrors selectively packets received from the switching device to the above intrusion detecting system in accordance with predetermined rules, and the network traffic flow control system transmits the packets to the corresponding real network in a case that a counterfeited packet is received from the intrusion detecting system through the mirroring interface.

Moreover, the network traffic flow control system in accordance with the present invention comprises additionally a rule inquiring and filtering module, which stores the rules for determining whether or not to cut off the received packets, and can cut off the real session by transmitting counterfeited packets containing a cut off message in case of a session to be cut off and packets containing a FIN finish or a RST reset flag.

### BRIEF DESCRIPTION OF THE DRAWINGS

FIG. 1 is a block diagram showing an internal constitution of the network traffic flow control system in accordance with an embodiment of the present invention.

FIG. 2 is a block diagram showing a constitution of the internal interface and the external interface.

FIG. 3 is a block diagram showing a constitution of the mirroring interface.

FIG. 4 is a block diagram showing a constitution of the communication/administration interface.

FIG. 5 is a block diagram showing the network traffic flow control system in accordance with the present invention as it is connected in a network.

FIG. 6 is a block diagram showing another connection of the network traffic flow control system in accordance with the present invention in a network.

FIG. 7 is a flow chart showing control process of a traffic flow by the traffic flow control system in accordance with the present invention.

### PREFERRED EMBODIMENTS OF THE INVENTION

The preferred embodiments of the present invention are described below in detail, with reference to the drawings.

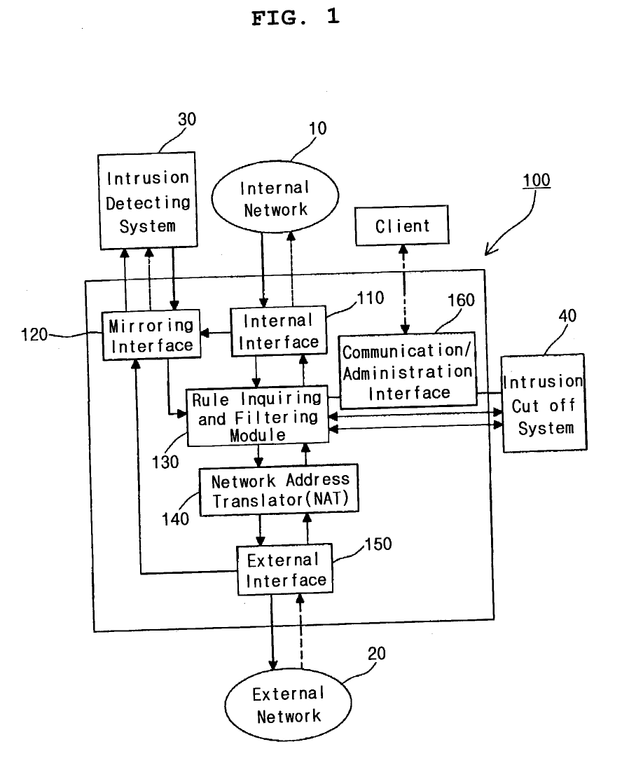

FIG. 1 is a block diagram showing an internal constitution of the network traffic flow control system in accordance with an embodiment of the present invention. As shown in FIG. 1, the above system 100 according to an embodiment of the present invention consists of an internal interface 110, a mirroring interface 120, a rule inquiring and filtering module 130, an NAT 140, an external interface 150, and a communication/administration interface 160.

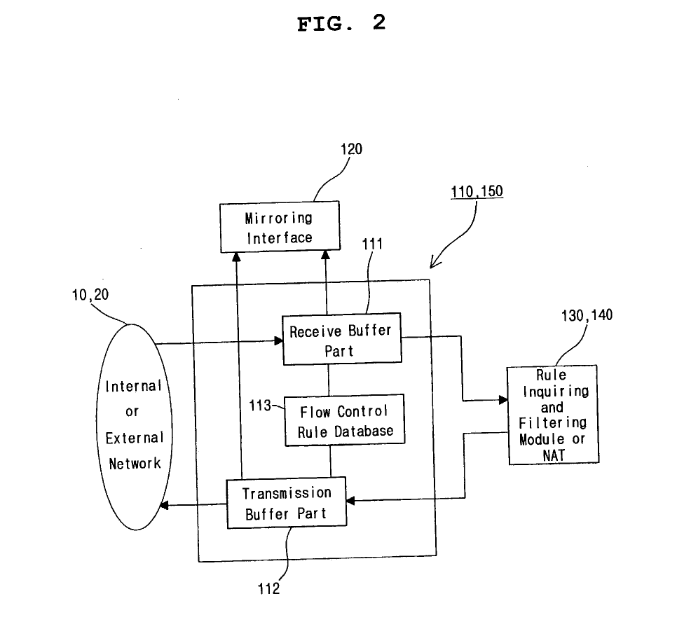

The above internal interface 110 transmits/receives packets from the internal network 10 to the external network 20 while connected to the internal network 10, the mirroring interface 120, and the rule inquiring and filtering module 130, and the above external interface 150 transmits/receives packets from the external network 20 to the internal network 10 while connected to the mirroring interface 120, the NAT 140, and the external network 20. A more detailed constitution of the above internal interface 110 and external interface 150 is shown in FIG. 2.

FIG. 2 is a block diagram showing a detailed constitution of the internal interface 110 and the external interface 150. As shown in FIG. 2, the internal/external interface 110, 150 is connected to the mirroring interface 120, the rule inquiring and filtering module 130, and the internal network 10 or the external network 20 while comprising inside thereof a receiving buffer part 111, a transmission buffer part 112, and a flow control rule database 113. The internal/external interface 110, 150 operates as follows.

First, if a packet is received from the internal/external network 10, 20, the packet is stored in the receiving buffer part 111, and then, it is determined with reference to the flow control rule database 113 whether the packet shall be mirrored. If the packet is determined to be one to be mirrored, then, the packet is transmitted to the mirroring interface 120 as well as to the rule inquiring and filtering module 130 or the NAT 140, after the packet has been re-scheduled.

If the packet is received from the rule inquiring and filtering module 130 or the NAT 140 as described above, the packet is stored in the transmission buffer part 112. And then, it is determined, with reference to the flow control rule database 112, whether the packet shall be mirrored. If the packet is determined to be one to be mirrored, then, the packet is transmitted to the mirroring interface 120 as well as to the internal/external network 10, 20, after the packet has been re-scheduled.

Here, it is confirmed, upon receiving the packet, whether a fragmentation has occurred. If a fragmentation has occurred, the packet is transformed into a whole normal packet through an IP reassemble process. For transmission of a packet, it is checked whether the packet to be transmitted is too large for the MTU size of the network interface. In a case that the packet is too large, the packet is IP fragmented, and then transmitted, which procedure is required for confirming the intrusion cut off rules or the intrusion detecting rules.

Furthermore, the capacity of the above receiving buffer part 111 as well as of the transmission buffer part shall be sufficiently large so that a packet loss due to the network congestion can be prevented.

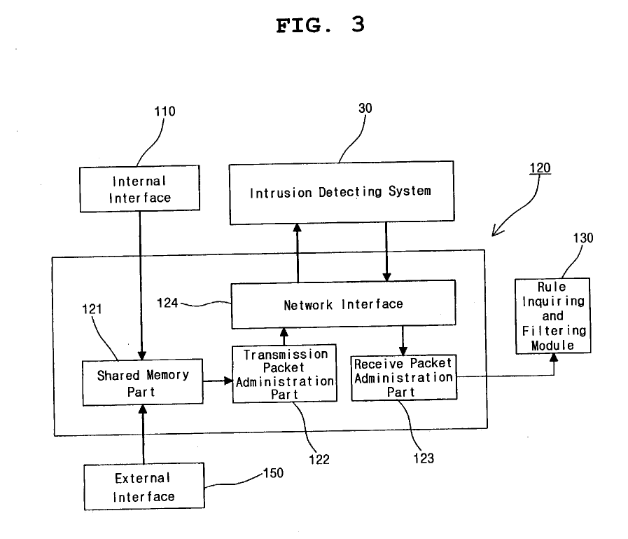

Now, a description of the mirroring interface 120 of FIG. 1 is given below. The mirroring interface performs mirroring of the whole or partial traffic flow in the port to ensure that only the necessary packets are transmitted from the internal interface 110 to the intrusion detecting system 30, while connected to the internal interface 110 and the intrusion detecting system 30. A detailed constitution of the mirroring interface 120 is shown in FIG. 3. As shown in FIG. 3, the mirroring interface 120 comprises a shared memory part 121, a transmission packet administration part 122, a receiving packet administration part 123, and a network interface 124. The mirroring interface having the above constitution operates as follows.

The above shared memory part 121, while connected to the internal interface 110 and the external interface 150, stores temporarily the packets received from these two interfaces. The above shared memory part 121 is additionally connected to the transmission packet administration part 122, which fetches the packets stored in the shared memory part 121 and transmits the same to the network interface 124, whereupon the network interface 124 transmits the received packets to the intrusion detecting system 30. In a case that a counterfeited packet for cut off of a TCP session is received, the receiving administration part 123 transmits the received packet to the rule inquiring and filtering module 130.

As next, a description on the rule inquiring and filtering module 130 of FIG. 1 is given below. As shown in FIG. 1, the rule inquiring and filtering module 130 redirects traffic to the intrusion cut off system in accordance with the predetermined intrusion cut off rules and intrusion detecting rules, while it is connected to the internal interface 110, the NAT 140, the communication/administration interface 160, and the intrusion cut off system 40. The rule inquiring and filtering module 130 fetches to store the cut off rules from the rule database stored in the communication/administration interface 160. Although the cut off rule to be stored in the rule inquiring and filtering module 130 may comprise all cut off rules used by the intrusion cut off system, only those cut off rules of the first layer through the fourth layer of the OSI hierarchy model shall preferably be stored in order to scatter the loads on the intrusion cut off system.

However, in a case that application of cut off rules of the fifth layer through the seventh layer is required, or authentication of a user or encoding is required, the packet can separately be filtered and transmitted to the intrusion cut off system 40. The above procedure enables inquiries of the cut off rule within only a short time, since the first layer through the fourth layer of the OSI hierarchy model are mere analyses of packets formed by standardized formats of the network. In addition, since many cut off rules exist normally for the cut off policy of IP and the port, the packets actually transmitted to the intrusion cut off system 40 shall be greatly reduced in comparison to the whole packets.

Thus, although a system with a small capacity can be connected with the intrusion cut off system, the whole system performs without a hitch. Upon receiving the packet from the rule inquiring and filtering module 130, the intrusion cut off system 40 determines whether or not to cut off an intrusion through the intrusion cut off rules, takes other steps necessary for the security, and transmits the packet to the network interface using a default route table of its own, whereby the system 100 in accordance with the present invention receives this packet, because there is only one path out for the packet. Upon receiving the packet from the intrusion cut off system 40, the rule inquiring and filtering module 130 transmits the packet to the internal interface 110 or to the NAT 140 after having confirmed the MAC address.

Now, a description of the NAT in FIG. 1 is given below. The NAT converts the address system of the internal network 10 into the address system of the external network 20, and vice versa, while connected to the above rule inquiring and filtering module 130 and the external interface 150. The NAT is one of major functions of the intrusion cut off system and harmonizes the address systems in a case that the IP address system of the internal network differs from that of the external network, and is mainly used when the IP address system of the internal network is an unauthorized IP address system. The packet is transmitted/received directly among the external interface 150, the rule inquiring and filtering module 130.

However, without an NAT 140, scattering of loads on the intrusion cut off system utilizing the function of NAT is not possible. In other words, all packets are transmitted to the linked intrusion cut off system in a case that NAT is not existent. If the NAT 140 is used, both the transmission IP address and the destination IP address of the packet are changed into authorized IP addresses. And then, the packet is corrected and transmitted to the external interface 150. In a case that the internal network is set to an unauthorized IP address, address of all packets is changed by the NAT 140.

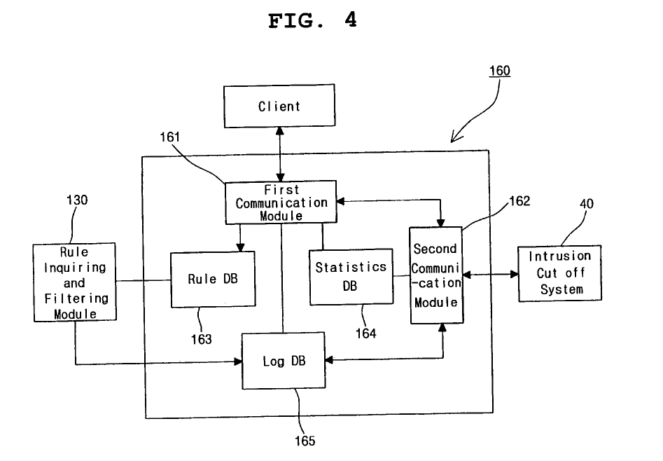

Next, the communication/administration interface 160 in FIG. 1 is explained below with reference to FIG. 4. The above communication/administration interface 160, being an interface to allow a system administrator to set up rules, to control the system, to administer the system, e.g. by inquiring a statistical information, etc., and to exchange, if necessary, the log statistics with the security system, is connected to the intrusion cut off system 40, the rule inquiring and filtering module 130, and the clients as shown in FIG. 4, and comprises in inside thereof a first communication module 161, a second communication module 162, a rule database 163, a statistics database 164, and a log database 165.

The above client being an administrator accessing the system 100 via a computer and the like, can manipulate through the first communication module 161 various rules in the rule database 163, by registering, correcting, deleting, etc. the same. In addition, the intrusion cut off system 40 provides also an application program interface (“hereinafter, API”) to allow sharing of the rules via the second and the first communication modules 162, 161. In this API, a capacity to store the cut off/allowance rules consisted of the protocol, the client IP, the server IP, the server ports etc., an IP list of the cut off exception clients, URLs to be cut off, IP lists of the internal network and the external network, etc. Further, the clients may access the network traffic log database 165 using the first communication module 161 to inquire the log information. Likewise, information stored in the log database 165 and in the statistics database 164 can be transmitted to the intrusion cut off system 40 via the second communication module 162 as defined by the rule database 163. In such case, the intrusion cut off system 40 can add the cut off contents and the statistics performed by itself to those performed by the present system 100 and report on the results of the addition.

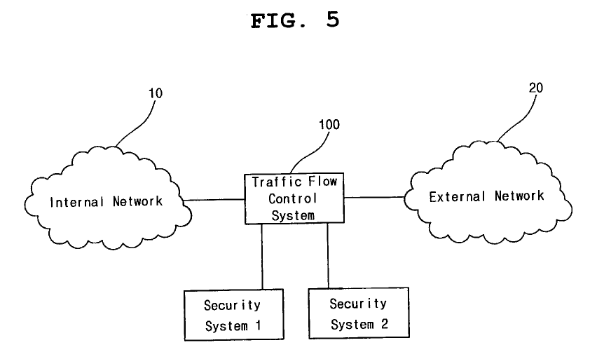

FIG. 5, being a block diagram showing the network traffic flow control system 100 in accordance with the present invention as it is connected in a network, shows a case where the system 100 in accordance with the present invention functions as a bridge. As shown in FIG. 5, the network flow control system 100 in accordance with the present invention is connected between the internal network 10 and the external network 20, and a plurality of intrusion cut off system 40 or intrusion detecting system as in FIG. 1 is also connected to the above system 100. In a network based on broadcasting such as the Ethernet, a packet destined to a specific host is broadcasted to the whole subnets.

Each network interface connected to the network is changed to a mode capable of fetching all packets. The network interface functions as a bridge with a switching function by confirming the MAC address among the OSI reference models of the destination in the packet, and transmitting the packet back to the corresponding network interface. Here, after analysis of the packets, the system processes the packets that it can process by itself and transmits other packets to be processed by the security system to the security system.

The security system checks whether to cut off these packets or to authenticate them, and then, sets up a path back to the system 100 and transmits those packets. If the traffic flow control system 100 of the present invention transmit the packets received from the security system via the corresponding network interface after confirming the MAC address, a communication is established.

In a case that the security system in FIG. 5 is an intrusion cut off system 30 in FIG. 1, the received packet is copied in accordance with predetermined rules and transmitted to the corresponding network interface after the MAC address of the packet has been confirmed. The above procedure is a flow mirroring function of the mirroring interface 120 as explained in FIG. 1 performed in respect to the whole or to a partial traffic. Here, network interface for the flow mirroring may be selected in plural in order to enable linkage to a plurality of systems.

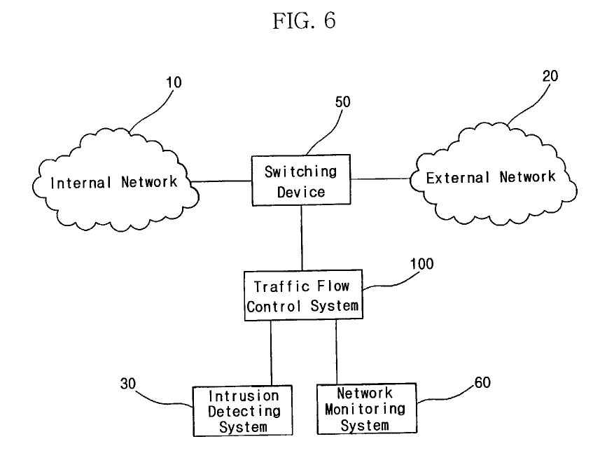

FIG. 6, being a block diagram for another connection in a network of the network traffic flow control system 100 in accordance with the present invention as described in FIGS. 1 through 4, shows the system as a packet collecting engine system without a bridge function. As shown in FIG. 6, the traffic flow control system 100 is connected to a switching device 50, while a plurality of intrusion detecting system or network monitoring system 60 is connected thereto. The system in FIG. 6, in difference to the system in FIG. 1, does not have the function to redirect the path and to transmit the packet, but rather has only the simple function of copying the packet. Here, although a linking with the intrusion cut off system is impossible, connection to a plurality of intrusion detecting systems or to network monitoring systems is possible without loading the network.

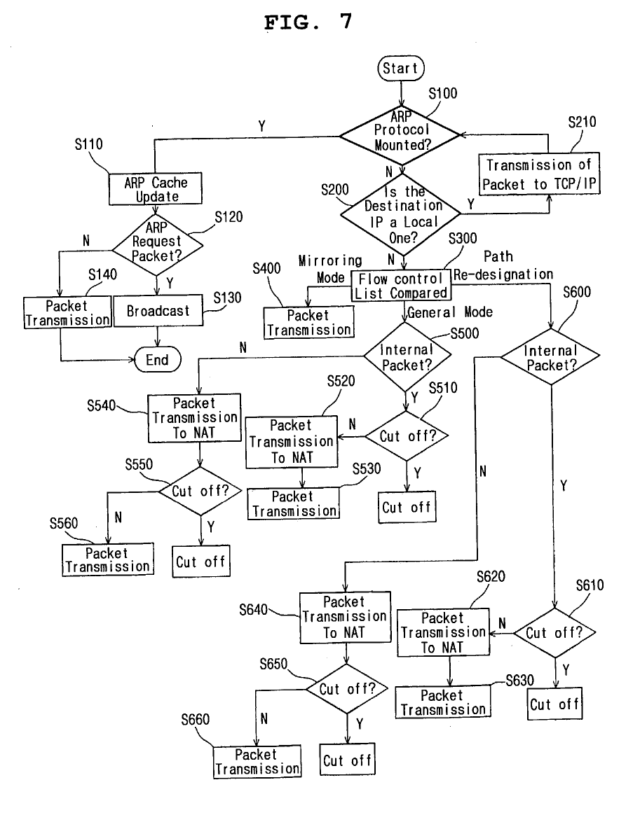

However, the network interface of the switching device, which connects the switching device 50 to the traffic flow control system 100 shall be defined as a mirroring port. FIG. 7 is a flow chart showing the detailed control process of the traffic flow by the network traffic flow control system as described above.

Upon receiving the packet, the system 100 confirms whether the packet contains an address resolution protocol (hereinafter, “ARP”) S100. If an ARP is contained, the MAC address of the starting location is updated at the ARP cache S110. Here, contents of the update are that the address of the corresponding data link layer belongs to how network interface.

Then, it is confirmed whether the packet is an ARP request packet S120. If the packet is an ARP request packet, it is broadcasted to all network interfaces owned by the system S130. If the packet is not an ARP request packet, but rather an ARP response packet, the network interface to which the address belongs is searched at the ARP cache using the MAC address of the destination, and the packet is transmitted to the corresponding interface S140. By proceeding as above, processing of the ARP request/response packet is terminated.

On the other hand, if the packet is one from a local TCP/IP stack, or one fetched from a network interface and not from an ARP packet, it is confirmed whether the IP address is a local one S200. If the destination IP address is a local one, the packet is transmitted to the TCP/IP stack S210.

If the destination IP address is not a local one, the defined values of the corresponding interfaces are fetched in sequence from the flow control list of the flow control rule database and are compared 300. In the flow control list, different modes such as general mode, path setting mode, and mirroring mode are listed Since the flow control list can comprise a plurality of mirroring modes or a plurality of path setting modes, processing of a packet can be completed after all the modes listed in the flow control list for each packet have been processed.

If the flow control list includes the mirroring mode at the step S300, the packet is transmitted to the corresponding network interface S400, and if not, the subsequent value on the flow control list is compared.

If the flow control list includes the general mode at the step S300, which means transmission of an ordinary packet, then, it is confirmed whether the packet is an internal packet S500. If the packet is an internal packet, it is transmitted to the rule inquiring and filtering module, to determine whether or not to cut off the packet S510. If the packet is one to be cut off, the packet is cut off, while the packet is transmitted to the NAT S520, if it is one to pass through.

If the address translation rule has been set up, the NAT transfers the packet to the packet transmission module and fetches the network interface from the ARP cache S530, and then, transmits the packet to the network interface after the NAT changes the source IP and the destination IP and reassembles the packet If the packet at the above step S500 is not an internal packet, the packet passes the NAT S540 to subsequently be transmitted to the rule inquiring and filtering module for determination as to whether or not to cut off S550. If the packet is one to be cut off, it is cut off, while the packet is transmitted to the corresponding network interface in a case that the packet is one to pass through S560. The reason why the sequence is changed according as whether the packet is an internal or an external packet, is that the cut off rules shall better be consistent with the network addresses for the sake of administration efficiency. If the cut off rules shall be generated in a state in which authorized IP and unauthorized IP exist in a mixture, administration of the system would be very difficult.

If the path is redirected at the above step S300, it is first confirmed whether the packet is an internal packet S600. The subsequent procedures are the same as those of the general mode described above, except for the part pertaining to the packet transmission, because the network interface to which the packet is to be transmitted is already determined when the path is redirected.

For reference, there are two methods for cutting off a packet i.e. by transmitting a counterfeit reset RST packet and by dropping DROP a packet. In a case that a switching type system is constituted as in FIG. 5, one among the following three methods may be opted: for transmitting a counterfeited packet consisted of a setting of a counterfeited packet containing a message saying that cut off has occurred, and a finish FIN flag; by transmitting a reset RST packet in a case that no such cut off message is contained; and by simply dropping DROP the packet A selection among these three methods is made based on the kinds of the protocol service or at disposition of the administrator. However, under a packet monitoring type network constitution as in FIG. 6, the packet dropping method cannot be adopted.

Although the present invention has been described above referring to the preferred embodiments of the invention, the scope of rights of the present invention is not limited thereto, but rather shall be determined by the appended claims, allowing various adaptations and modifications, without departing the scope and spirit of the present invention as those skilled in the art will understand.

Industrial Applicability

As described above, the present invention provides a network traffic control system equipped with a bridge function, which allows logically separated networks to have a same address without changing the constitution and environment of the existing network, while physically separating the network. In addition, the above system can scatter the loads in connection with a plurality of systems for control of the traffic in a high-speed network equipped with a bridge function.

The present invention further allows to reduce the loads on a security system by reducing the traffic through wholly or partially filtering the packets in a plurality of intrusion cut off systems, intrusion detecting systems, etc. while collecting packets in one network.

The present invention can prevent development of a bottleneck in an intrusion cut off system, by preventing transmission of all packets to the intrusion cut off system using an NAT installed in it.

In addition, the present invention provides the administrators with convenience in administration, by transforming the intrusion rules detected by the intrusion detecting system to intrusion policies, so that they are reflected in the intrusion rules.

What is claimed is:

1. A network traffic flow control system installed between two or more broadcasting based networks is connected to one or more intrusion cut off systems that determine whether or not to cut off transmission/receiving of the packets between said networks in accordance with predetermined rules, and is connected to one or more intrusion detecting systems that monitors flow of the packets between said networks in accordance with predetermined rules, comprising:
an internal interface for transmitting/receiving the packets while connected to the internal network;
an external interface for transmitting/receiving the packets while connected to the external network;
a rule inquiring and filtering module which determines whether or not to cut off the packets received from said internal interface or said external interface determines in accordance with predetermined rules, while it is connected to said internal interface, said external interface, and said intrusion cut off system; and
a mirroring interface, which mirrors selectively the packets received from said internal interface or said external interface to said intrusion detecting system in accordance with predetermined rules, while it is connected to said internal interface, said external interface, and said intrusion detecting system,
wherein said predetermined rules in said rule inquiring and filtering module and in said mirroring interface control flow of the packets on the data link layer.

2. The network traffic flow control system as set forth in claim 1, further comprising:
a NAT which translates the address system of said internal network into the address system of said internal network, and vice versa, while inserted between said rule inquiring and filtering module and said external interface.

3. The network traffic flow control system as set forth in claim 1 or claim 2, wherein each of said internal interface and the external interface comprises:
a receiving buffer part for storing temporarily the packets received from said internal network or said external network, respectively;
a transmission buffer part for storing temporarily the packets to be transmitted to said internal network or said external network, respectively; and
a flow control rule database, which stores rules for determining whether or not to mirror the packets stored in said receiving buffer part to said mirroring interface,
whereby said receiving buffer part determines whether or not to mirror the packets stored in said internal network or said external network with reference to said flow control rule database, and then, transmits the corresponding packet to said mirroring interface in a case that the mirroring rule has been declared, while it transmits the corresponding packet to said rule inquiring and filtering module or to said NAT, in a case that no mirroring rule has been declared; and
said transmission buffer part determines whether or not to mirror the packets received from said rule inquiring and filtering module or said NAT with reference to said flow control rule database, and then, transmits the corresponding packet to said mirroring interface in a case that the mirroring rule has been declared, while it transmits the corresponding packet to said internal network or to said external network, in a case that no mirroring rule has been declared

4. The network traffic flow control system as set forth in claim 3, wherein said mirroring interface comprises:
a shared memory part for storing temporarily the packets mirrored from said internal interface or said external interface;
a transmission packet administration part for fetching the packets from said shared memory part to subsequently transmit the same to said network interface;
a network interface for receiving the packets from said transmission packet administration part to subsequently transmit the same to said intrusion detecting system; and
a receiving packet administration part for transmitting the received packets to said rule inquiring and filtering module if the packet has been received from said intrusion detecting system through said network interface.

5. The network traffic flow control system as set forth in claim 1 or claim 2, further comprising a communication/administration interface comprising:
a first communication module, which enables the clients to access;
a second communication module, which enables access to the intrusion cut off system;
a rule database, which stores predetermined intrusion cut off rules and intrusion detecting rules, and transmits the same to said rule inquiring and filtering module;
a log database for storing records on all packets passing the network; and
a statistics database for storing various statistical information of the packets in the network.

6. The network traffic flow control system as set forth in claim 4, further comprising a communication/administration interface comprising:
a first communication module, which enables the clients to access;
a second communication module, which enables access to the intrusion cut off system;
a rule database, which stores predetermined intrusion cut off rules and intrusion detecting rules, and transmits the same to said rule inquiring and filtering module;
a log database for storing records on all packets passing the network; and
a statistics database for storing various statistical information of the packets in the network.

7. The network traffic flow control system as set forth in claim 5, wherein said packet cut off rules are distributed to said rule database, to said rule inquiring and filtering module, and to said intrusion cut off system in accordance with predetermined criteria..

8. The network traffic flow control system as set forth in claim 6, wherein said packet cut off rules are distributed to said rule database, to said rule inquiring and filtering module, and to said intrusion cut off system in accordance with predetermined criteria..

9. The network traffic flow control system as set forth in claim 8, wherein said cut off rules generated by the results of detecting by said intrusion detecting system are transmitted immediately to said rule database, to said rule inquiring and filtering module, and to said intrusion cut off system, so that the corresponding data are updated.

10. A network traffic flow control system which is installed between two or more networks based on broadcasting through the switching device is characterized by being connected to one or more intrusion detecting systems that monitor flow of the packets in accordance with predetermined rules, and by performing multiple mirroring to said one or more intrusion detecting systems through a plurality of network interfaces.

11. The network traffic flow control system as set forth in claim 10, further comprising:
a mirroring interface which mirrors selectively packets received from said switching device to said intrusion detecting system in accordance with predetermined rules,
and the network traffic flow control system is characterized by transmitting the packets to the corresponding real network if a counterfeited packet has been received from said intrusion detecting system through said mirroring interface.

12. The network traffic flow control system as set forth in claim 10 or claim 11, further comprising:
a rule inquiring and filtering module which stores the rules for determining whether or not to cut off the received packets,
and the network traffic control system is characterized by cutting off the real session after transmitting counterfeited packets including a cut off message for a session to be cut off and packets including a FIN(finish) or a RST(reset).
